(19) United States
(12) Patent Application Publication
(10) Pub. No.: US 2011/0180730 A1
(43) Pub. Date: Jul. 28, 2011

(54) COUNTERFEIT DETECTOR

(75) Inventors: Jong Jae Kim, Daejeon (KR); Sung Hyun Joo, Daejeon (KR); Sun Woong Shin, Gyeonggi-do (KR); Jae Young Choi, Seoul (KR); Hee Jeong Ban, Gyeonggi-do (KR); Yong Hoon Kang, Seoul (KR); Sang Cheol Lee, Gyeonggi-do (KR); Eu Gene Kim, Seoul (KR)

(73) Assignees: Korea Minting, Security Printing & ID Card Operating Corp., Daejeon (KR); Seoul Opto Device Co., Ltd., Kyunggi-do (KR)

(21) Appl. No.: 13/122,198

(22) PCT Filed: Aug. 31, 2009
(86) PCT No.: PCT/KR2009/004867

§ 371 Date: Apr. 1, 2011

(30) Foreign Application Priority Data
Oct. 1, 2008 (KR) 10-2008-0096556

(51) Int. Cl. G07D 7/12

(52) U.S. Cl. 250/492.1

(57) ABSTRACT

The present disclosure provides a counterfeit detector which identifies whether a security document or the like is authentic by irradiating UV rays from UV LEDs onto fluorescent security marks formed on the security document. UV rays emitted from the UV LEDs are independently condensed and reflected, thus enabling a user to more effectively identify the fluorescent security marks that are formed in special shapes using UV fluorescent material.

### RELATED APPLICATION

This is a 371 of International Application No. PCT/KR2009/004867, with an international filing date of Aug. 31, 2009 (WO 2010/038945 A2, published Apr. 8, 2010), which is based on Korean Patent Application No. 10-2008-0096556 filed Oct. 1, 2008.

### TECHNICAL FIELD

The present disclosure relates generally to counterfeit detectors and, more particularly, to a counterfeit detector which identifies a security document or paper money which has a fluorescent security mark that is formed in a special shape using UV (ultraviolet) fluorescent material.

### BACKGROUND

Generally, a process of identifying security documents or the like, for example, a bank bill, negotiable securities, an ID card, etc., using security marks formed on the security documents is divided into four levels.

In detail, a first level is the level of identifying a security document with the naked eye. In the second level, a simple tool is used. A third level is the level of identifying the security document using a machine. A fourth level is a forensic level of detecting a hidden security element.

A method using fluorescent material is included as part of the second level. This method is widely used in most of security documents because the accuracy of the identification is high despite using a relatively simple tool.

Fluorescent fiber, fluorescent sewing thread, fluorescent silver lines, fluorescent images and characters are representative examples of such fluorescent security marks. These fluorescent security marks play an important role in the security and identification of a variety of security documents or the like, for example, bank bills, negotiable securities, ID cards, etc.

Meanwhile, representative counterfeit detectors for discerning fluorescent security marks were proposed in KR 20-0343494 dated Feb. 19, 2004, KR 20-0252294 dated Oct. 17, 200i, KR 20-0288671 dated Aug. 29, 2002 and KR 10-2004-0023193 dated Mar. 18, 2004. These documents use in common a UV lamp to discern a fluorescent security mark. However, because the light power of the UV lamp is low, the operation of discerning the fluorescent security mark is ineffective. As well, the lifetime of the UV lamp is relatively short and thus not economical. In addition, the use of mercury may pollute the environment.

In an effort to overcome the above problems, techniques of discerning a fluorescent security mark using UV LEDs were proposed in KR 20-0395636 dated September 2005 and KR 20-0406411 dated Jan. 10, 2006. However, in these techniques, a light condensing structure is unsatisfactory, with the result that the identification of a target is not easy.

To solve the problem of unsatisfactory light condensing of the UV LEDs of the conventional techniques, the use of a cylinder lens and individual reflective parts was proposed in KR-10-2008-0024360 dated Mar. 18, 2008.

### SUMMARY

The present disclosure has been made in an effort to solve the problem of unsatisfactory light condensing of the UV LEDs in a manner different from that of KR 10-2008-0024360 dated Mar. 18, 2008. The present disclosure is not limited, however, to solving that one problem.

The present disclosure provides a counterfeit detector in which UV rays emitted from UV LEDs are independently reflected by individual reflective parts, thus minimizing light loss attributable to dispersion of light, thereby enabling a user to more effectively discern whether a security document is genuine.

The present disclosure provides a counterfeit detector which selectively irradiates UV rays having different wavelengths onto a security document, thus enabling the user to more clearly discern the security document.

In a counterfeit detector according to an embodiment of the present disclosure, a casing defines a reception space therein. An opening is formed in the casing so that the reception space communicates with outside through the opening. A reflective plate is installed in the reception space of the casing. The reflective plate is exposed to outside through the opening of the casing. Individual concave reflective parts are arranged in series on the reflective plate to independently reflect UV rays. UV LEDs are respectively disposed in the individual reflective parts. The UV LEDs irradiate a security document.

In the present disclosure, UV rays emitted from UV LEDs are independently reflected by individual reflective parts and are irradiated onto a security document at high brightness without light loss attributable to dispersion of light. Thus, a user can more easily identify whether a fluorescent security mark of the security document is authentic. Hence, the reliability of the identification can be increased.

Furthermore, the individual reflective parts have conical shapes and are arranged in series such that UV rays emitted from the UV LEDs partially overlap with each other, thus forming intensive irradiation areas on the security document. Thereby, the identification of the security document can be more clearly conducted.

In addition, the UV LEDs may emit different wavelengths. In this case, individual irradiation areas are formed on the security document, so that a specific fluorescent security mark that reacts to only a corresponding wavelength can be more clearly discerned. The use of a wavelength selection switch reduces the power consumption and increases the lifetime of the LEDs.

Therefore, the present disclosure can more easily identify not only bank bills but also security documents including negotiable securities, thus promoting counterfeit prevention and preventing related crime.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating a counterfeit detector, according to an embodiment of the present disclosure;

FIG. 2 is an exploded perspective view illustrating the counterfeit detector of FIG. 1;

FIG. 3 is a partial sectional view illustrating the counterfeit detector of FIG. 1;

FIG. 4 is a perspective view showing the identification operation of the counterfeit detector of FIG. 1;

FIG. 5 is a perspective view illustrating a counterfeit detector, according to another embodiment of the present disclosure; and

FIGS. 6 through 9 are perspective views showing the identification operation of the counterfeit detector FIG. 5.

### DETAILED DESCRIPTION

Hereinafter, preferred embodiments of the present disclosure will be described in detail with reference to the attached drawings.

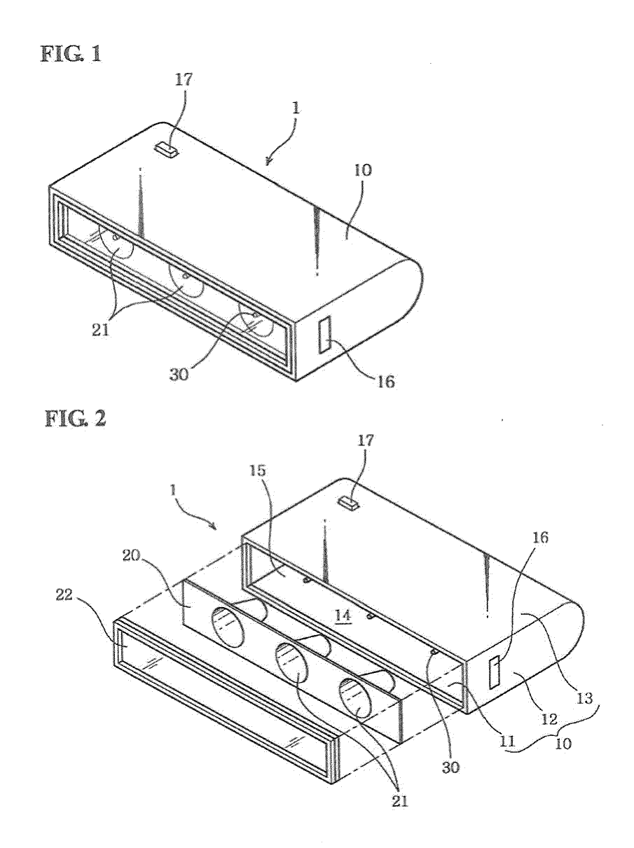

FIG. 1 is a perspective view illustrating a counterfeit detector, according to an embodiment of the present disclosure, showing the counterfeit detector having individual UV LEDs.

FIG. 2 is an exploded perspective view illustrating the counterfeit detector. This drawing shows a reflective plate which is mounted to an opening of a casing and includes individual reflective parts which are arranged in series such that they individually reflect UV rays. In addition, a transparent window is disposed ahead of the reflective plate.

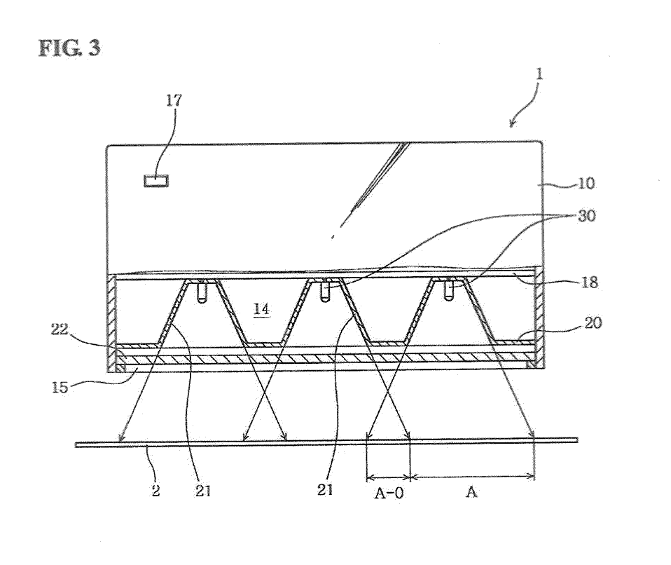

FIG. 3 is a partial sectional view illustrating the counterfeit detector of the embodiment of the present disclosure, showing the reflective plate, UV LEDs and the transparent window which are consecutively installed in the casing.

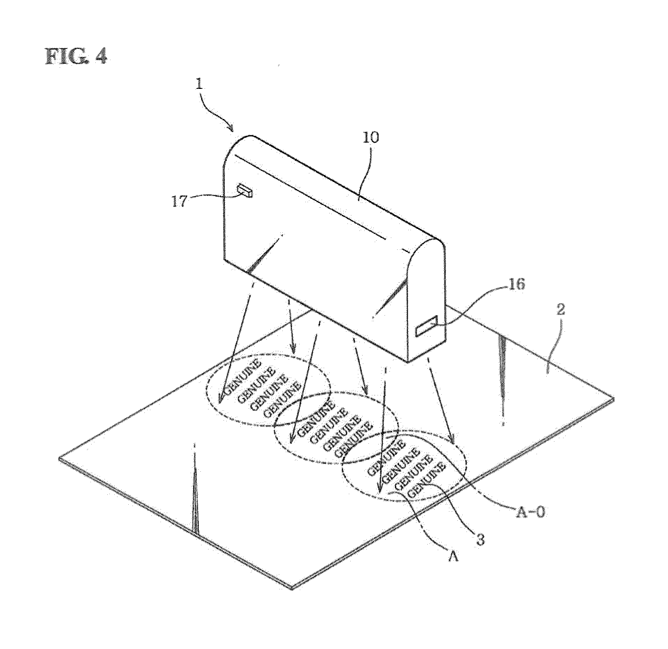

FIG. 4 is a perspective view showing the identification operation of the counterfeit detector according to the embodiment of the present disclosure, showing the UV LEDs irradiating a security document to discern a fluorescent security mark.

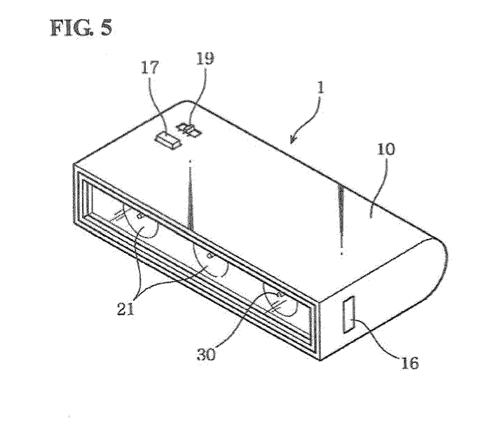

FIG. 5 is a perspective view illustrating a counterfeit detector, according to another embodiment of the present disclosure, showing a wavelength selection switch that is provided on a casing and independently operates UV LEDs.

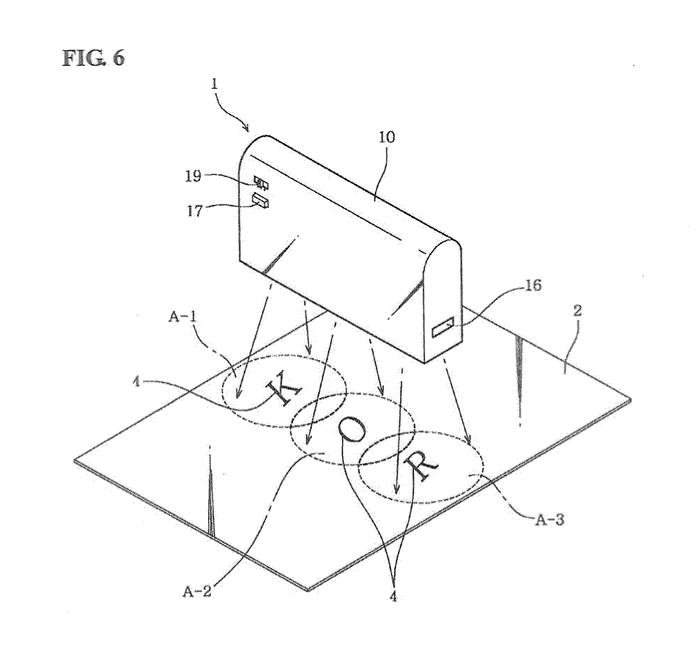

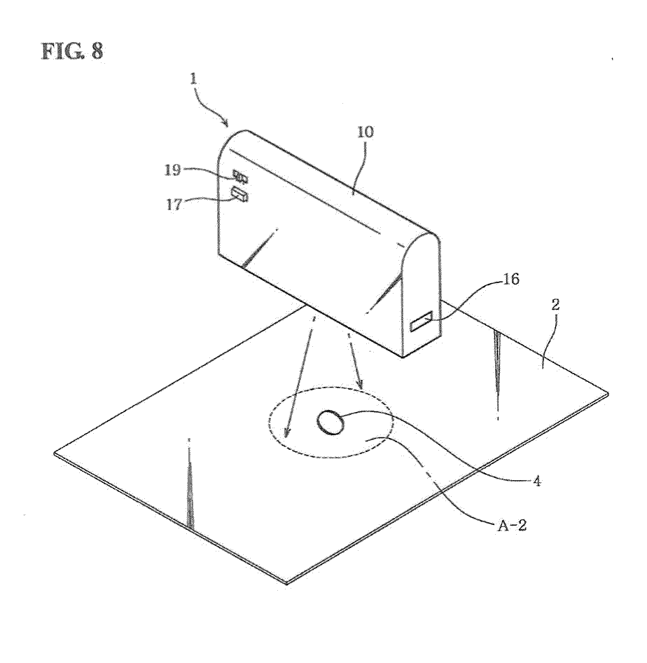

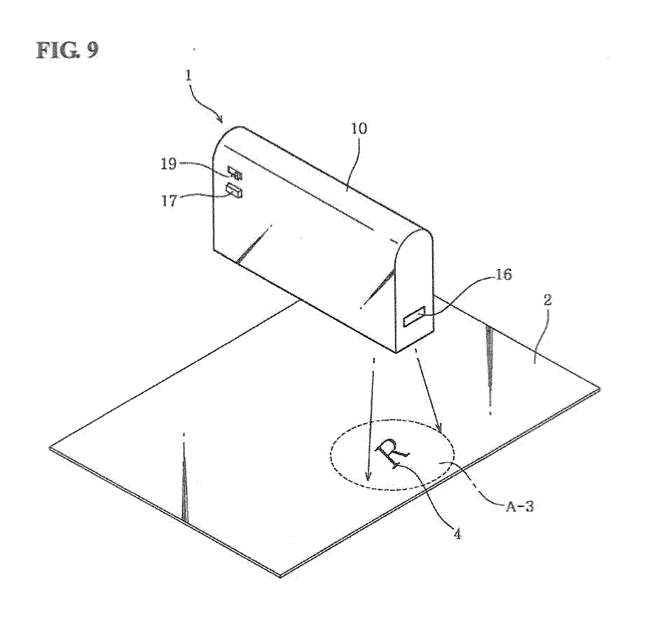

FIGS. 6 through 9 are perspective views showing the identification operation of the counterfeit detector of FIG. 5, showing the UV LEDs that independently irradiate a security document with different wavelengths to discern fluorescent security marks.

In detail, the counterfeit detector 1 includes the casing 10 which defines the whole external appearance, the reflective plate 20 which has the individual reflective parts 21 therein, and the LEDs 30 which independently irradiate the security document 2.

The casing 10 comprises a bottom plate 11 and sidewalls 12. In addition, an upper plate 13 is coupled to the upper ends of the sidewalls 12 such that reception space 14 in which the components are installed is defined in the casing 10. As shown in FIGS. 1 and 2, the opening 15 is formed in the front end of the casing 10, so that the reception space 14 communicates with the outside through the opening 15.

Typically, the casing 10 is formed by injection molding using synthetic resin. Specially, the casing 10 may be made of metal to enhance the durability.

In the casing 10, a battery may be removably disposed in the reception space 14 to supply power to the UV LEDs 30. Alternatively, without having a battery, a lead wire that extends outwards from the casing 10 may be connected to an electric outlet provided in a building, thus supplying power to the LEDs 30. As such, the use of a battery is optional.

Furthermore, a residual quantity indicator 16 is provided on the sidewall 12 of the casing 10 such that when the battery is installed in the reception space 14, a user can observe the residual quantity of the battery at any time. The residual quantity indicator 16 lets the user easily know the time when the battery has to be replaced with a new one.

In addition, a power switch 17 is provided on the casing 10 to turn on/off the UV LEDs 30. Typically, the power switch 17 is disposed on the upper plate 13 of the casing 10.

The casing 10 may be provided with a belt clip (not shown) or a snap cord (not shown). In this case, the portability of the counterfeit detector 1 can be increased.

The reflective plate 20 reflects UV rays emitted from the UV LEDs 30 such that the UV rays advance towards the security document 2, thus defining irradiation areas A on the security document 2. As shown in FIGS. 2 and 3, the individual reflective parts 21 are formed in series in the reflective plate 20 to independently reflect UV rays emitted from the LEDs 30.

In detail, the individual reflective parts 21 are formed in series in the concave shapes to individually control paths along which UV rays pass from the UV LEDs 30, thus condensing UV rays. In the present disclosure, as an embodiment of the configuration of the individual reflective parts 21, three individual reflective parts 21 are formed in series in the reflective plate 20.

It is preferable that the individual reflective parts 21 be arranged in the reflective plate 20 such that UV rays that irradiate the security document 2 and form the irradiation area A overlap with each other to form the intensive irradiation area A-O on the security document 2.

The reason for this is that when UV rays overlap with each other, the intensity of radiation is increased and the security document 2 is thus further brightened, so that the user can more clearly observe the fluorescent security mark 3.

For this, each individual reflective part 21 has a conical shape, and the individual reflective parts 21 are spaced apart from each other at regular intervals appropriate to form the intensive irradiation area A-O on the security document 2 by overlapping UV rays.

Therefore, UV rays emitted from the UV LEDs 30 are independently reflected by the corresponding individual reflective parts 21 and thus form the irradiation areas A on the security document 2. Particularly, UV rays overlap with each other to form the intensive irradiation areas A-O, thus allowing the user to more easily ascertain whether the security document 2 is authentic or not.

Preferably, the reflective plate 20 including the individual reflective parts 21 is made of material coated with nickel (Ni) or silver (Ag) to minimize light loss attributable to absorption and dispersion when condensing and reflecting UV rays. More preferably, the reflective plate 20 is made of aluminum which is highly reflective of UV rays.

The transparent window 22 which covers the opening 15 may be provided ahead of the reflective plate 20 to prevent penetration of impurities. The transparent window 22 is made of material having high transmittance to minimize a loss of UV rays.

The UV LEDs 30 radiate UV rays onto the fluorescent security mark 3 of the security document 2 to expose the fluorescent security mark 3. To achieve this purpose, the UV LEDs 30 create ultraviolet wavelengths using nitride material.

Preferably, the UV LEDs 30 emit UV rays having wavelengths of 400 nm or less. The reason for this is that the fluorescent security mark formed on the security document 2 is made of material which reacts only UV rays having a wavelength of 400 nm or less.

Therefore, the UV LEDs 30 that emit ultraviolet wavelengths of 400 nm or less must be used to facilitate the ascertainment of the fluorescent security mark 3.

As shown in FIGS. 1 through 3, the UV LEDs 30 are respectively disposed in the individual reflective parts 21 of the reflective plate 20. The UV LEDs 30 are connected to a circuit board 18 which is installed in the reception space 14, so that they can be controlled by the power switch 17 which is electrically connected to the circuit board 18.

The circuit board 18 has a circuit to prevent the UV LEDs 30 from being damaged by overcurrent, as a configuration that is well known in the art pertaining to the counterfeit detector 1.

Each UV LED 30 emits UV rays when power is supplied thereto by manipulating the power switch 17. The UV rays emitted from each UV LED 30 are reflected and condensed by the corresponding individual reflective part 21 and are radiated onto the security document 2 through the opening 15.

The process of identifying the fluorescent security mark 3 of the security document 2 using the counterfeit detector 1 will be explained in detail below.

First, by turning on the power switch 17, power is supplied to the high-power UV LEDs 30 which have peak wavelengths of 365 nm and are respectively disposed in the individual reflective parts 21 and connected to the circuit board 18 in the casing 10. Thus, the UV LEDs 30 emit UV rays. The emitted UV rays form UV ray irradiation areas A each of which has an area of 20 cm×10 cm on the security document 2 at a distance of 15 cm.

In other words, when the power switch 17 provided on the casing 10 is turned on, the UV LEDs 30 which are electrically connected to the power switch 17 emit UV rays. Then, the UV rays are condensed and reflected by the corresponding individual reflective parts 21. As a result, the circular irradiation areas A are formed on the security document 2, as shown in FIG. 4.

As mentioned above, the intensive irradiation areas A-O are formed on the security document 2 depending both on the configuration of the individual reflective parts 21 and on the intervals at which the individual reflective parts 21 are spaced apart from each other.

Therefore, the irradiation areas A and the intensive irradiation areas A-O enable the user to more clearly observe the fluorescent security mark 3 of the security document 2, thus facilitating the determination of whether the fluorescent security mark 3 formed, for example, on a bank bill, negotiable securities, a passport, an ID card, etc., is authentic.

Meanwhile, in the counterfeit detector 1 according to the present disclosure, UV LEDs 30 which are disposed in the individual reflective parts 21 may emit different wavelengths. In this case, the counterfeit detector 1 enables the user to identify specific fluorescent security marks 4 which react to different wavelengths of UV rays.

For example, in the case where UV LEDs 30 which respectively emit center wavelengths of 254 nm, 313 nm and 365 nm are disposed in the individual reflective parts 21, individual irradiation areas A-1, A-2 and A-3 are formed on the security document 2, as shown in FIG. 6. Therefore, several specific fluorescent security marks 4 which are formed on a bank bill, negotiable securities, a passport, an ID card, etc., can be identified.

In this embodiment a wavelength selection switch 19 is provided on the casing 10 to select one of the UV LEDs 30 having different wavelengths.

As shown in FIG. 5, the wavelength selection switch 19 is typically disposed on the upper plate 13 of the casing 10 to allow the user to select a UV LED 30 that emits a corresponding wavelength. After the wavelength selection switch 19 selects one of the UV LEDs 30, when the power switch 17 is turned on, UV rays having corresponding wavelengths are emitted from the selected UV LED 30.

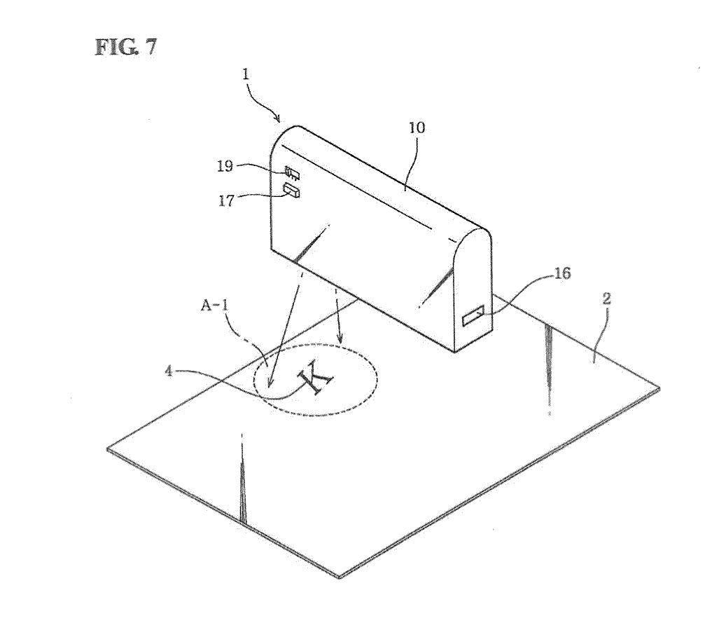

Hence, as shown in FIGS. 7 through 9, the UV LED 30 that is selected by the wavelength selection switch 19 irradiates UV rays onto the security document 2, thus forming an individual irradiation area A-1, A-2 or A-3. Then, a specific fluorescent security mark 4 that reacts to the corresponding wavelength is expressed on the security document 2 within the individual irradiation area A-1, A-2 or A-3. As a result, the counterfeit detector 1 according to this embodiment of the present disclosure can more clearly ascertain whether the security document 2 is authentic, despite reducing the power consumption and ensuring the expected lifetime of the UV LEDs 30.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims. The foregoing examples are provided merely for the purpose of explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. A counterfeit detector, comprising:
a casing defining a reception space therein, with an opening formed in the casing so that the reception space communicates with outside through the opening;
a reflective plate installed in the reception space of the casing, the reflective plate being exposed to outside through the opening of the casing, with individual concave reflective parts arranged in series on the reflective plate to independently reflect UV (ultraviolet) rays; and
UV LEDs respectively disposed in the individual reflective parts, the UV LEDs irradiating a security document.

2. The counterfeit detector as set forth in claim 1, wherein each of the individual reflective parts has a conical shape, and the individual reflective parts are arranged such that UV rays irradiating the security document overlap with each other.

3. The counterfeit detector as set forth in claim 1, wherein the UV LEDs disposed in the individual reflective parts emit UV rays having have different wavelengths.

4. The counterfeit detector as set forth in claim 1, further comprising:
a wavelength selection switch provided on the casing to select one of the UV LEDs emitting different wavelengths.

5. The counterfeit detector as set forth in claim 2, further comprising:
a wavelength selection switch provided on the casing to select one of the UV LEDs emitting different wavelengths.

6. The counterfeit detector as set forth in claim 3, further comprising:
a wavelength selection switch provided on the casing to select one of the UV LEDs emitting different wavelengths.
